(19) United States
(12) Patent Application Publication
(10) Pub. No.: US 2005/0269351 A1
(43) Pub. Date: Dec. 8, 2005

(54) Method and mechanism to seal a vessel for a highly pressurized combustion-supportable or flammable gas

(75) Inventors: Masao Sato, Koshigaya (JP); Masayoshi Miyake, Saitama (JP); Ryuichi Yazaki, Iwatsuki (JP)

Correspondence Address: KODA & ANDROLIA, 2029 CENTURY PARK EAST, SUITE 1140, LOS ANGELES, CA, 90067, US

(73) Assignee: Nippon Tansan Gas Co., Ltd.

(21) Appl. No.: 11/127,686

(22) Filed: May 12, 2005

(30) Foreign Application Priority Data
May 20, 2004 (JP) 2004-149881

(51) Int. Cl. B67B 7/00; G01F 11/00; B67D 5/42

(52) U.S. Cl. 222/1

(57) ABSTRACT

In a method relating to this invention to seal a vessel, firstly, a discharge mouth and a charge mouth are provided respectively to the vessel, and the discharge mouth is previously sealed at openable state. Then the charge mouth is surrounded by an airtight space, and the charge mouth is sealed in the space after the highly pressurized combustion-supportable or flammable gas is charged into the space and the vessel. In a mechanism relating to this invention to seal a vessel, a discharge mouth and a charge mouth respectively provided to a vessel for a highly pressurized combustion-supportable or flammable gas are sealed respectively, and the discharge mouth only is sealed at openable state.

### BACKGROUND OF THE INVENTION

1. Technical Field of the Invention

This invention relates to a method and a mechanism to seal a vessel for a combustion-supportable gas, such as an oxygen, a nitrous oxide and so on, a flammable gas, such as a LPG, a hydrogen and so on, or a mixture of these gases in highly pressurized condition.

2. Prior Art

In production of mini gas cartridges charged with a combustion-supportable or flammable gas, a sealing plate cannot be welded because of these gases easily cause explosions. Therefore, vessels charged with a combustion-supportable or flammable gas have to be sealed by such method like caulking and so on. However, because it is difficult to obtain well sealing condition by such methods other than welding, those methods bring some problems in safety or economical views in case where they are applied for goods required to maintain pressure and amount of inside gas for long period to be used at disaster.

Therefore, this applicant has proposed a method (the first prior art) disclosed in Japanese Utility publication H03-032299 to improve sealing condition of a vessel sealed by such methods like caulking and so on. According to this method, sealing condition of a vessel is improved by welding a cap covers a sealed portion of the vessel charged with a gas.

On the other hand, this applicant has proposed a sealing method, a sealing apparatus and a mechanism of a charge mouth (the second prior arts) disclosed in Japanese Patent application 2002-364524 (Japanese Patent publication 2004-197783) to enable to weld a sealing plate on a vessel charged with a highly pressurized combustion-supportable or a flammable gas.

### SUMMARY OF THE INVENTION

However, according to the first prior art, there is such a problem that the vessel is not able to be easily opened for use because its dual sealing mechanism requires so strong power to be opened by user's own hands and large apparatus to open is needed.

Further, according to the second prior arts, there is such a problem that an interlock system to prevent explosion or other accidents tends to be complex and it makes costs higher to keep safety operation and to maintain the apparatus.

Therefore, this invention aims to propose a method and a mechanism to seal a vessel for a highly pressurized combustion-supportable or flammable gas, whereby the vessel discharged with the highly pressurized combustion-supportable or flammable gas can be sealed without complex interlock system, and such a sealed portion that maintains well sealing condition but is easily opened for use can be obtained.

In a method relating to this invention to seal a vessel for a highly pressurized combustion-supportable or flammable gas, a discharge mouth and a charge mouth are provided respectively to the vessel. The discharge mouth is previously sealed at openable state. Then, the charge mouth is surrounded by an airtight space, and the charge mouth is sealed in the space after the highly pressurized combustion-supportable or flammable gas is charged into the space and the vessel.

The charge mouth may be sealed by inserting a metal pin into the charge mouth before surrounding the charge mouth by the airtight space, wherein which metal pin is a truncated cone having a groove extending on a side plane to a smaller top plane, which smaller top plane is positioned in the charge mouth and another end portion of which groove on the side plane is positioned out of the charge mouth, and pushing the metal pin in the space to a position where the groove sinks in the charge mouth after charging the highly pressurized gas.

The charge mouth may be sealed by inserting a metal pipe into the charge mouth before surrounding the charge mouth by the airtight space, wherein end portion of which metal pipe protrudes from the charge mouth, and crushing the end portion in the space after charging the highly pressurized gas.

A mechanism relating to this invention to seal a vessel for a highly pressurized combustion-supportable or flammable gas has a discharge mouth and a charge mouth respectively provided to the vessel. Further the discharge mouth and the charge mouth are able to be sealed respectively, and the discharge mouth only is sealed at openable state.

In the mechanism, the discharge mouth may be sealed by a safety sealing plate welded thereon.

In the mechanism the charge mouth may be sealed by a metal pin of a truncated cone pushed therein.

In the mechanism, the charge mouth may be inserted by a metal pipe and sealed by crushed end of the metal pipe.

In the method or the mechanism, the sealed charge mouth may be covered air tightly with a secondary sealing means.

In the method or the mechanism, the secondary sealing means may be made up with an annular wall portion and a sealing plate, which annular wall portion encircles the charge mouth and which sealing plate is soldered onto a top plane of the annular wall portion.

In the method or the mechanism, the secondary sealing means may be made up with an annular wall portion and a sealing plate, which annular wall portion encircles said charge mouth and which sealing plate is welded onto a top plane of the annular wall portion.

In the method or the mechanism, the secondary sealing means may be made up with an annular wall portion and a threaded plug, which annular wall portion encircles the charge mouth and which threaded plug is screwed to an inner face of the annular wall portion.

In the method or the mechanism, the secondary sealing means may be made up with an annular wall portion and a coupling cap nut, which annular wall portion encircles the charge mouth and which coupling cap nut is screwed to an outer face of the annular wall portion.

### BRIEF DESCRIPTION OF THE DRAWINGS

FIGS. 1(a), (b) and (c) are drawings show a condition wherein a charge mouth of a vessel is sealed which vessel is settled in a charging apparatus to enhance the sealing method. (a) is a front section shows a general view of the apparatus. (b) is an enlarged front section shows a condition of the charge mouth before sealed. (c) is an enlarged front section shows a condition of the charge mouth just after sealed.

FIGS. 2(a), (b) and (c) are drawings show a condition wherein the charge mouth of the vessel is air tightly covered by a sealing means, which vessel is settled in the charging apparatus. (a) is a front section shows a general view of the apparatus. (b) is an enlarged front section shows a condition of the charge mouth before air tightly covered. (c) is an enlarged front section shows a condition of the charge mouth just after air tightly covered.

FIGS. 3(a), (b) and (c) are drawings show enlarged charge mouth sealed by the metal pipe. (a) is a front section shows a condition of the charge mouth before sealed. (b) is a front section shows a condition of the charge mouth just after sealed.

### DETAILED DESCRIPTION OF THE PREFERRED EMBODIMENT

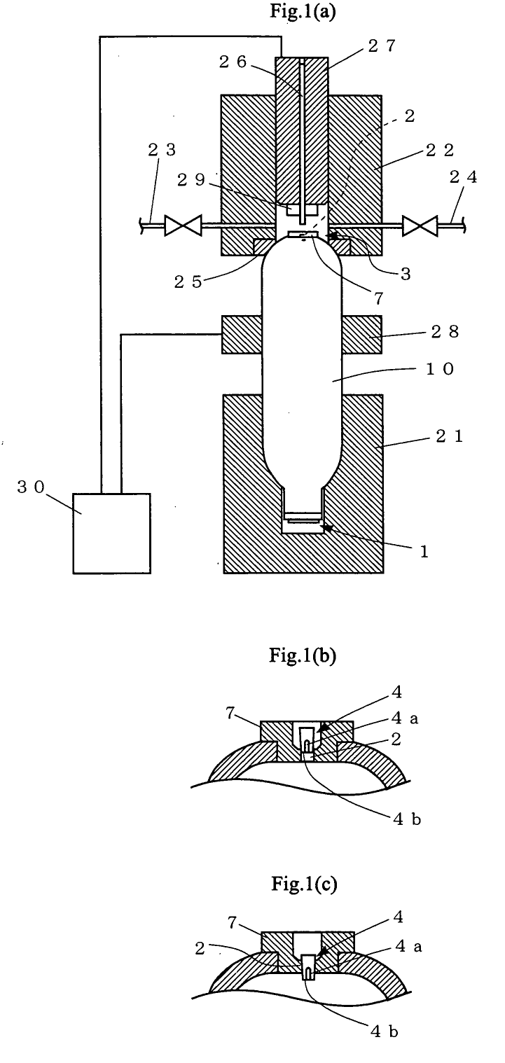

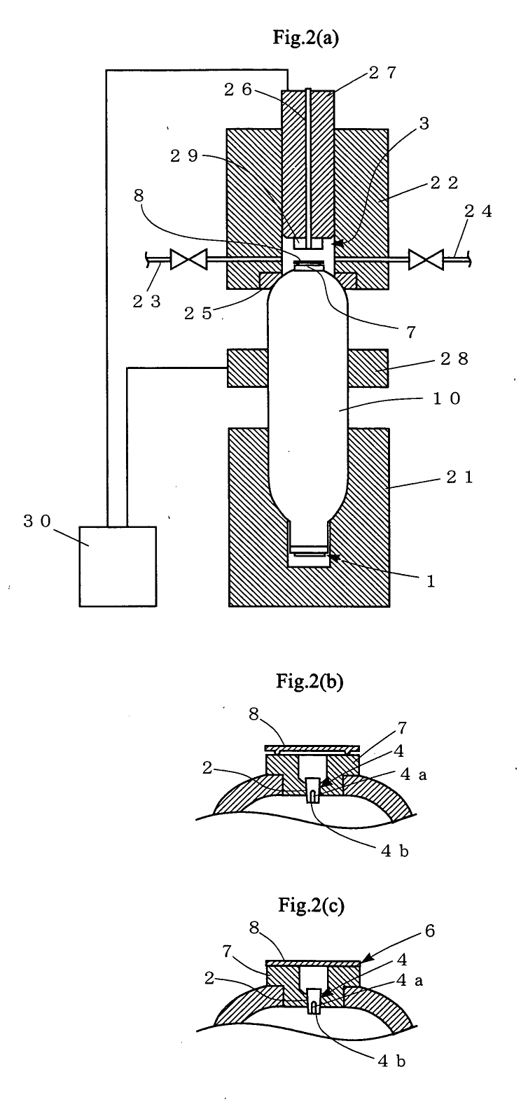

An example of a method of this invention to seal a vessel for a highly pressurized combustion-supportable or flammable gas is described below as referring FIG. 1 and FIG. 2. FIG. 1 shows a condition wherein a charge mouth of a vessel is sealed, which vessel is settled in a charging apparatus to enhance the sealing method. FIG. 1(a) is a front section shows a general view of the apparatus. FIG. 1(b) is an enlarged front section shows a condition of the charge mouth before sealed. FIG. 1(c) is an enlarged front section shows a condition of the charge mouth just after sealed. FIG. 2 shows a condition wherein the charge mouth of the vessel is air tightly covered with a sealing means, which vessel is settled in the charging apparatus. FIG. 2(a) is a front section shows a general view of the apparatus. FIG. 2(b) is an enlarged front section shows a condition of the charge mouth before air tightly covered. FIG. 2(c) is an enlarged front section shows a condition of the charge mouth just after air tightly covered.

This charging apparatus is to charge an oxygen gas into a vessel 10 at predetermined pressure (19.2 MPa) and has a vessel receiver 21 and a support member 22. The support member 22 is arranged to move toward and away from the vessel receiver 21 and has an inside space 3 wherein a top end portion of the vessel 10 stably supported by the vessel receiver 21 is kept under airtight condition. The space 3 is provided with an exhaust pass 23 and an oxygen injection pass 24, which pass 23 is arranged to be opened or closed according to situation and connected to a vacuum pump, which pass 24 is arranged to be opened or closed according to situation and connected to an oxygen supplying means, whereby pressure and property of an inside gas can be adjusted. Further, a sealing packing 25 is set on a contacting portion whereon the vessel 10 contacts to the supporting member 22, and the space 3 is arranged to maintain airtight condition with the supporting member 22 pressed onto the top end portion of the vessel 10.

As the vessel 10 to be charged with the oxygen gas and sealed by using this apparatus, such the vessel that having a discharge mouth 1 and a charge mouth 2 for highly pressurized oxygen gas respectively provided thereon is applied. The discharge mouth 1 is previously sealed at openable state.

To charge the oxygen gas, the vessel 10 is positioned facing the charge mouth 2 to the supporting member 22 and is set on the vessel receiver 21, the supporting member 22 is pressed onto the vessel 10 in condition wherein both the drawing pass 23 and the oxygen injection pass 24 are closed, and the charge mouth 2 is surrounded by the airtight space 3. Next, the drawing pass 23 is opened, and after the space 3 and the inside of the vessel 10 is vacuumed the drawing pass 23 is again closed, and then the highly pressurized oxygen gas is charged into the space 3 and the inside of the vessel 10 by opening the oxygen injection pass 24. When the inside pressure of the space 3 and the vessel 10 reaches to predetermined value, the vessel 10 is in the condition where it is charged with the pressurized oxygen gas at predetermined pressure.

After complement of charging process, the charge mouth 2 is sealed in the space 3, and then the vessel 10 charged with the highly pressurized oxygen gas is obtained.

According to this method, the charge mouth 2 does not have to be sealed at openable state as long as the discharge mouth 1 is sealed at openable state because of the discharge mouth 1 and the charge mouth 2 are provided respectively. Namely, the charge mouth 2 does not have to be sealed by a sealing plate, and many kinds of sealing techniques become to be adaptable. Therefore, by selecting proper techniques to obtain well sealing condition which techniques can be carried out in the space 3 under the oxygen gas atmosphere, it is able to seal the vessel 10 charged with the highly pressurized oxygen gas without complex interlock system and further able to maintain well sealed condition after sealing. Furthermore, regarding to the discharge mouth 1, because of being independent from the charge mouth 2 and being sealed separately without limitation of condition wherein the sealing operation is carried out, by selecting proper sealing techniques, sealing it at openable state can be easily enhanced and well sealed condition can be maintained after sealing.

To seal the charge mouth 2, a metal pin 4 of a truncated cone having a groove 4a extending on a side plane to a smaller top plane 4b is applied. The supporting member 22 is provided with a push bar 26 which is arranged to move toward and away from the vessel 10 and to put a pushing force onto the metal pin 4 in the space 3.

To be used for sealing the charge mouth 2, this metal pin 4 has to be provisionally set at the charge mouth 2 before the charge mouth 2 is surrounded by the space 3. At the provisional setting condition, the smaller top plane 4b is positioned in the charge mouth 2 and another end portion of the groove 4a on the side plane is positioned out of the charge mouth, as shown in FIG. 1(b). Then the metal pin 4 is pushed in the space 3 to a position where the groove 4a sinks in the charge mouth 2 after charging the highly pressurized oxygen gas, as shown in FIG. 1(c), and the charge mouth 2 is closed.

In this case, because the highly pressurized oxygen gas is smoothly charged into the vessel via the groove 4a and sealing is enhanced easily by only pushing process, it can be carried out in the limited space 3 surrounding the charge mouth 2. Further, a well sealed condition can be maintained after sealing by deformation of the metal pin 4 and the inside wall of the charging mouth 2.

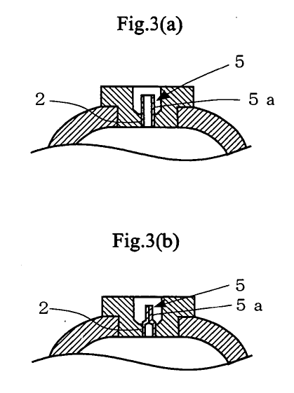

For sealing the charge mouth 2, other techniques also can be applied and, for example, a metal pipe 5 as shown in FIG. 3 may be applied. FIG. 3 shows enlarged charge mouth sealed by the metal pipe. FIG. 3(a) is a front section shows a condition of the charge mouth before sealed, and FIG. 3(b) is a front section shows a condition of the charge mouth just after sealed.

To be used for sealing the charge mouth 2, this metal pipe 5 has to be inserted into the charge mouth 2 before the charge mouth 2 is surrounded by the space 3. By this insertion, the metal pipe 5 is inserted to a position wherein an end portion 5a of the metal pipe 5 protrudes from the charge mouth 2 as shown in FIG. 3(a). In case a leakage through a space between the metal pipe 5 and the charge mouth 2 cannot be prevented by their deformation, they may be adhered each other by such the way like soldering. Then, an end portion 5a is crushed in the space 3 after charging the highly pressurized oxygen gas, as shown in FIG. 3(b), and the charge mouth 2 is sealed.

In this case also, as same manner as the case the metal pin 4 is used, because the highly pressurized oxygen gas is smoothly charged into the vessel 10 via the inside pass of the metal pipe 5 and sealing is easily enhanced by crushing the end portion 5a of the metal pipe 5, it can be carried out in the limited space 3 surrounding the charge mouth 2. Further, a well sealed condition can be maintained after sealing by deformation of the metal pin 5 and the inside wall in the charging mouth 2.

This apparatus enables to cover the charge mouth 2 air tightly with a secondary sealing means 6.

In this case, sealed condition of the charge mouth 2 can be improved.

The secondary sealing means 6 is made up with an annular wall portion 7 and a sealing plate 8, which annular wall portion 7 is formed by a collar welded on a bottom portion of the vessel 10 and encircles the charge opening 2, and which sealing plate 8 is welded onto a top plane of the annular wall portion 7. Then, the secondary sealing means 6 is formed around the charge mouth 2 in steps described below by using a cylinder 27 provided to the support member 22.

Firstly, the support member 22 is removed from the vessel 10 whose charge mouth 2 is sealed. Before removing, because the space 3 is filled with the highly pressurized oxygen gas, it is prefer in safety view to decrease the inside pressure of the space 3 via the drawing pass 23.

The support member 22 is removed while the sealing plate 8 is set on the annular wall portion 7, and then the support member 22 is again pressed onto the vessel 10 after setting the sealing plate 8. A bottom side electrode 28 is fixed to an outer circumference of the vessel 10. The bottom side electrode may be fixed there at the starting condition as shown in FIG. 1(a).

Next, the cylinder 27 is moved toward the vessel 10 and a topside electrode 27 fixed to a front end portion of the cylinder 27 is pressed onto the sealing plate 8. Then the sealing plate 8 is welded by projection welding using a welding machine 30, and the secondary sealing means 6 air tightly surrounding the charge mouth 2 is formed.

The secondary sealing means 6 may be made by other structure as long as it can cover the charge mouth 2 air tightly. For example, it may be made by such ways that soldering the sealing plate 8 onto the annular wall portion 7, screwing a threaded plug or a coupling cap nut instead of the sealing plate 8 to the annular wall portion 7 and so on. By any way, the structure is made up with the annular wall portion 7 to encircle the charge mouth 2 and the closure member for annular wall portion 7, the charge mouth 2 can be covered air tightly by easy processes without affecting sealing operation of the charging mouth 2. According to a structure of the charge mouth 2, the sealing plate 8 may be welded or soldered directly to the charge mouth 2 without providing the annular wall portion 7.

In FIG. 2(a), the support member 22 is pressed onto the vessel 10 to stabilize the vessel 10, and as result, the space 3 surrounds the charge mouth 2 whereon the sealing plate 8 is set. However, because the charge mouth 2 is sealed by the metal pin 4, it is not necessary to surround the charge mouth 2 by the space 3 for process of welding the sealing plate 8. The vessel 10 can be supported by only the vessel receiver 21 as long as the sealing plate 8 is smoothly pressed, and then the processes of sealing the charge mouth 2 by the metal pin 4 and of welding the sealing plate 8 onto the annular wall portion can be respectively enhanced by different apparatuses. Further, because the discharge mouth 1 can be sealed by normal welding, the method of this invention can be enhanced by existing charging apparatus and existing resistance welding apparatus without new equipment and it is also one of the advantages of the method of this invention. Further more, in the case where the charge mouth 2 is surrounded by the space 3 at welding process, it is another advantage that the welding quality can be improved by making the inside of the space 3 under an inert gas atmosphere.

The discharge mouth 1 is sealed by a safety sealing plate welded thereon.

In this case, sealing the discharge mouth 1 at openable state can be easily enhanced and well sealed condition can be maintained after sealing. The safety sealing plate disclosed in Japanese Patent publication S63-34360 is preferably used for this purpose.

### EFFECT OF THE INVENTION

According to the method of this invention to seal a vessel for a highly pressurized combustion-supportable or flammable gas, the charge mouth does not have to be sealed at openable state as long as the discharge mouth is sealed at openable state because of the discharge mouth and the charge mouth are provided respectively. Namely, the charge mouth does not have to be sealed by a sealing plate, and many kinds of sealing techniques become to be adaptable. Therefore, by selecting proper techniques to obtain well sealing condition which techniques can be carried out in the limited space under the combustion-supportable or flammable gas atmosphere, it is able to seal the vessel charged with the highly pressurized combustion-supportable or flammable gas without complex interlock system and further able to maintain well sealed condition after sealing. Furthermore, regarding to the discharge mouth, because of being independent from the charge mouth and being sealed separately without limitation of condition wherein the sealing operation is carried out, by selecting proper sealing techniques (for example, a technique of welding a known safety sealing plate), sealing it at easily openable state can be easily enhanced and well sealed condition can be maintained after sealing.

As the technique to seal the charge mouth, it is preferable to apply a metal pin of a truncated cone having a groove extending on a side plane to a smaller top plane. According to this technique, because a highly pressurized gas is smoothly charged into the vessel via the groove and sealing is enhanced easily by only pushing process, it can be carried out in the limited space surrounding the charge mouth. Further, well sealed condition can be maintained after sealing by deformation of the metal pin and the inside wall of the charging mouth.

As another technique to seal the charge mouth, it is also preferable to apply a metal pipe. According to this technique, because a highly pressurized gas is smoothly charged into the vessel via the inside pass of the metal pipe and sealing is enhanced easily by crushing the end portion of the metal pipe, it can be carried out in the limited space surrounding the charge mouth. Further, well sealed condition can be maintained after sealing by deformation of the metal pin and the inside wall in the charging mouth.

The mechanism of this invention to seal a vessel for a highly pressurized combustion-supportable or flammable gas is obtained by operating the method of this invention and brings as same effect as the method of this invention. Namely, because the discharge mouth and the charge mouth respectively provided to the vessel for a highly pressurized combustion-supportable or flammable gas are sealed respectively and only the discharge mouth is sealed at openable state, many kinds of techniques become adaptable for sealing operation of the charge mouth which sealing operation has to be carried out in limited operation space. Then, by selecting proper sealing techniques (for example, a technique of using a metal pin or a metal pipe described above), it is able to seal the vessel charged with the highly pressurized combustion-supportable or flammable gas without complex interlock systems and further able to maintain well sealed condition after sealing.

In case the discharge mouth of this sealing mechanism is sealed by a safety sealing plate welded thereon, sealing it at openable state can be easily enhanced and further well sealed condition can be maintained after sealing.

Regarding to the charge mouth, in case the technique of pushing the metal pin or crushing the metal pipe inserted therein are applied for sealing, well sealed condition can be maintained after sealing by deformation of the metal pin and the inside wall of the charging mouth or the metal pipe.

In case the sealed charge mouth of this invention is covered air tightly with a secondary sealing means, sealed condition of the charge mouth can be improved.

Further, in case the secondary sealing means is made up with an annular wall portion to encircle the charge mouth and a closure member for the annular wall portion, the charge mouth can be covered air tightly by easy processes without affecting sealing operation of the charging mouth. In case the closure member for the annular wall portion is a sealing plate soldered onto a top plane of the annular wall portion, a sealing plate welded onto a top plane of the annular wall portion, a threaded plug screwed to an inner face of the annular wall portion or a coupling cap nut screwed to an outer face of the annular wall portion, existing techniques can be easily applied.

The disclosure of Japanese Patent Application No. 2004-149881 filed May 20th, 2004 including specification, drawings and claims is incorporated herein by reference in its entirety.

1. A method to seal a vessel (10) for a highly pressurized combustion-supportable or flammable gas, comprising previously sealing a discharge mouth (1) at openable state, which discharge mouth (1) is provided to the vessel (10) apart from a charge mouth (2) provided to the vessel (10);
surrounding said charge mouth (2) by an airtight space (3);
charging said highly pressurized combustion-supportable or flammable gas into said space (3) and said vessel (10); and
sealing said charge mouth (2) in said space (3).

2. The method to seal a vessel for a highly pressurized combustion-supportable or flammable gas as claimed in claim 1, wherein the charge mouth (2) is sealed by inserting a metal pin (4) into said charge mouth (2) before surrounding said charge mouth (2) by said airtight space (3), which metal pin (4) is a truncated cone having a groove (4a) extending on a side plane to a smaller top plane (4b), which smaller top plane (4b) is positioned in said charge mouth (2) and another end portion of which groove (4a) on said side plane is positioned out of said charge mouth (2); and
pushing said metal pin (4) in said space (3) to a position where said groove (4a) sinks in said charge mouth (2) after charging said highly pressurized gas.

3. The method to seal a vessel for a highly pressurized combustion-supportable or flammable gas as claimed in claim 1, wherein the charge mouth (2) is sealed by inserting a metal pipe (5) into said charge mouth (2) before surrounding said charge mouth (2) by said airtight space (3), end portion (5a) of which metal pipe (5) protrudes from said charge mouth (2); and
crushing said end portion (5a) in said space (3) after charging said highly pressurized gas.

4. The method to seal a vessel for a highly pressurized combustion-supportable or flammable gas as claimed in claim 1, wherein the charge mouth (2) is covered air tightly with a secondary sealing means (6).

5. The method to seal a vessel for a highly pressurized combustion-supportable or flammable gas as claimed in claim 4, wherein said secondary sealing means (6) is made up with an annular wall portion (7) and a sealing plate (8), which annular wall portion (7) encircles said charge opening (2) and which sealing plate (8) is soldered onto a top plane of said annular wall portion (7).

6. The method to seal a vessel for a highly pressurized combustion-supportable or flammable gas as claimed in claim 4, wherein said secondary sealing means (6) is made up with an annular wall portion (7) and a sealing plate (8), which annular wall portion (7) encircles said charge opening (2) and which sealing plate (8) is welded onto a top plane of said annular wall portion (7).

7. The method to seal a vessel for a highly pressurized combustion-supportable or flammable gas as claimed in claim 4, wherein said secondary sealing means (6) is made up with an annular wall portion (7) and a threaded plug, which annular wall portion (7) encircles said charge opening (2) and which threaded plug is screwed to an inner face of said annular wall portion (7).

8. The method to seal a vessel for a highly pressurized combustion-supportable or flammable gas as claimed in claim 4, wherein said secondary sealing means (6) is made up with an annular wall portion (7) and a coupling cap nut, which annular wall portion (7) encircles said charge opening (2) and which coupling cap nut is screwed to an outer face of said annular wall portion (7).

9. A mechanism to seal a vessel (10) for a highly pressurized combustion-supportable or flammable gas, having a discharge mouth (1) and a charge mouth (2) respectively provided to said vessel (10);
said discharge mouth (1) and said charge mouth (2) are able to be sealed respectively; and
said discharge mouth (1) only is sealed at openable state.

10. The mechanism to seal a vessel (10) for a highly pressurized combustion-supportable or flammable gas as claimed in claim 9, wherein said discharge mouth (1) is sealed by a safety sealing plate welded thereon.

11. The A mechanism to seal a vessel (10) for a highly pressurized combustion-supportable or flammable gas as claimed in claim 9, wherein said charge mouth (2) is sealed by a metal pin (4) of a truncated cone pushed therein.

12. The mechanism to seal a vessel (10) for a highly pressurized combustion-supportable or flammable gas as claimed in claim 9, wherein said charge mouth (2) is inserted by a metal pipe (5) and sealed by crushed end of said metal pipe (5).

13. The mechanism to seal a vessel (10) for a highly pressurized combustion-supportable or flammable gas as claimed in claim 9, wherein said sealed charge mouth (2) is covered air tightly with a secondary sealing means (6).

14. The mechanism to seal a vessel (10) for a highly pressurized combustion-supportable or flammable gas as claimed in claim 13, wherein said secondary sealing means (6) is made up with an annular wall portion (7) and a sealing plate (8), which annular wall portion (7) encircles said charge mouth (2) and which sealing plate (8) is soldered onto a top plane of said annular wall portion (7).

15. The mechanism to seal a vessel (10) for a highly pressurized combustion-supportable or flammable gas as claimed in claim 13, wherein said secondary sealing means (6) is made up with an annular wall portion (7) and a sealing plate (8), which annular wall portion (7) encircles said charge mouth (2) and which sealing plate (8) is welded onto a top plane of said annular wall portion (7).

16. The mechanism to seal a vessel (10) for a highly pressurized combustion-supportable or flammable gas as claimed in claim 13, wherein said secondary sealing means (6) is made up with an annular wall portion (7) and a threaded plug, which annular wall portion (7) encircles said charge mouth (2) and which threaded plug is screwed to an inner face of said annular wall portion (7).

17. The mechanism to seal a vessel (10) for a highly pressurized combustion-supportable or flammable gas as claimed in claim 13, wherein said secondary sealing means (6) is made up with an annular wall portion (7) and a coupling cap nut, which annular wall portion (7) encircles said charge mouth (2) and which coupling cap nut is screwed to an outer face of said annular wall portion (7).

18. The mechanism to seal a vessel (10) for a highly pressurized combustion-supportable or flammable gas as claimed in claim 11, wherein said sealed charge mouth (2) is covered air tightly with a secondary sealing means (6).

19. The mechanism to seal a vessel (10) for a highly pressurized combustion-supportable or flammable gas as claimed in claim 12, wherein said sealed charge mouth (2) is covered air tightly with a secondary sealing means (6).

20. The mechanism to seal a vessel (10) for a highly pressurized combustion-supportable or flammable gas as claimed in claim 18, wherein said secondary sealing means (6) is made up with an annular wall portion (7) and a sealing plate (8), which annular wall portion (7) encircles said charge mouth (2) and which sealing plate (8) is soldered onto a top plane of said annular wall portion (7).

21. The mechanism to seal a vessel (10) for a highly pressurized combustion-supportable or flammable gas as claimed in claim 19, wherein said secondary sealing means (6) is made up with an annular wall portion (7) and a sealing plate (8), which annular wall portion (7) encircles said charge mouth (2) and which sealing plate (8) is soldered onto a top plane of said annular wall portion (7).

22. The mechanism to seal a vessel (10) for a highly pressurized combustion-supportable or flammable gas as claimed in claim 18, wherein said secondary sealing means (6) is made up with an annular wall portion (7) and a sealing plate (8), which annular wall portion (7) encircles said charge mouth (2) and which sealing plate (8) is welded onto a top plane of said annular wall portion (7).

23. The mechanism to seal a vessel (10) for a highly pressurized combustion-supportable or flammable gas as claimed in claim 19, wherein said secondary sealing means (6) is made up with an annular wall portion (7) and a sealing plate (8), which annular wall portion (7) encircles said charge mouth (2) and which sealing plate (8) is welded onto a top plane of said annular wall portion (7).

24. The mechanism to seal a vessel (10) for a highly pressurized combustion-supportable or flammable gas as claimed in claim 18, wherein said secondary sealing means (6) is made up with an annular wall portion (7) and a threaded plug, which annular wall portion (7) encircles said charge mouth (2) and which threaded plug is screwed to an inner face of said annular wall portion (7).

25. The mechanism to seal a vessel (10) for a highly pressurized combustion-supportable or flammable gas as claimed in claim 19, wherein said secondary sealing means (6) is made up with an annular wall portion (7) and a threaded plug, which annular wall portion (7) encircles said charge mouth (2) and which threaded plug is screwed to an inner face of said annular wall portion (7).

26. The mechanism to seal a vessel (10) for a highly pressurized combustion-supportable or flammable gas as claimed in claim 18, wherein said secondary sealing means (6) is made up with an annular wall portion (7) and a coupling cap nut, which annular wall portion (7) encircles said charge mouth (2) and which coupling cap nut is screwed to an outer face of said annular wall portion (7).

27. The mechanism to seal a vessel (10) for a highly pressurized combustion-supportable or flammable gas as claimed in claim 19, wherein said secondary sealing means (6) is made up with an annular wall portion (7) and a coupling cap nut, which annular wall portion (7) encircles said charge mouth (2) and which coupling cap nut is screwed to an outer face of said annular wall portion (7).
